(19) United States
(12) Patent Application Publication
(10) Pub. No.: US 2007/0002137 A1
(43) Pub. Date: Jan. 4, 2007

(54) Aegis safetynet guardian system

(75) Inventors: Richard Charles Grosser, Palm Desert, CA (US); Eric Dunbar Johnson, Scottsdale, AZ (US)

Correspondence Address: AEGIS ASSESSMENTS, INC., 7975 NORTH HAYDEN RD., SUITE D-363, SCOTTSDALE, AZ, 85258, US

(73) Assignee: Aegis Assessments, Inc.

(21) Appl. No.: 11/168,242

(22) Filed: Jun. 29, 2005

(51) Int. Cl. H04N 7/18; H04N 9/47

(52) U.S. Cl. 348/143

(57) ABSTRACT

A portable wireless tracking device that uses radio-frequency identification (RFID) technology to monitor the location and physical condition of emergency personnel at the scene of an emergency incident. RFID technology uses radio-transmitting interrogators to send out radio waves to preprogrammed receiver computer chips which respond to the radio query with another radio signal. If the frequency is not correct, the receiver or interrogator will not recognize it. The invention also uses wireless remote stations that are placed in high rise buildings or other large commercial or infrastructure locations to provide facility managers and emergency responders with a reliable wireless emergency management and communications system. The remote stations can include broadband video, audio, two-way radio, as well as chemical and air flow data from life safety devices that can be used to monitor, direct, communicate and share with public safety agencies.

### FIELD OF THE INVENTION

The invention is directed to the problems associated with gaining knowledge of the tactical situation in buildings during emergencies or disasters without putting first responders or occupants into harm's way.

### BACKGROUND OF THE INVENTION

A major problem for first responders in emergency situations gaining detailed knowledge of what is happening inside a structure. It is necessary to know what the nature of the problem is, where it is located, and its probable progression. While most public buildings have installed alarm and video systems, they all rely on a hard-wired infrastructure which is highly susceptible to disruptions due to mechanical and/or electrical failures within the building. Additionally, the information furnished by these permanently installed systems is extremely limited. The Guardian can provide this functionality.

### BRIEF SUMMARY OF THE INVENTION

The invention (hereinafter referred as the “Guardian”) seeks to solve these problems through the use of a self-organizing wireless data collection and reporting system that has no reliance on any pre-existing infrastructure. There is currently no simple method to know the situation extant in a structure without sending personnel into that structure. There is also no system that will report the location of people within the building and provide for two-way communication to facilitate escape.

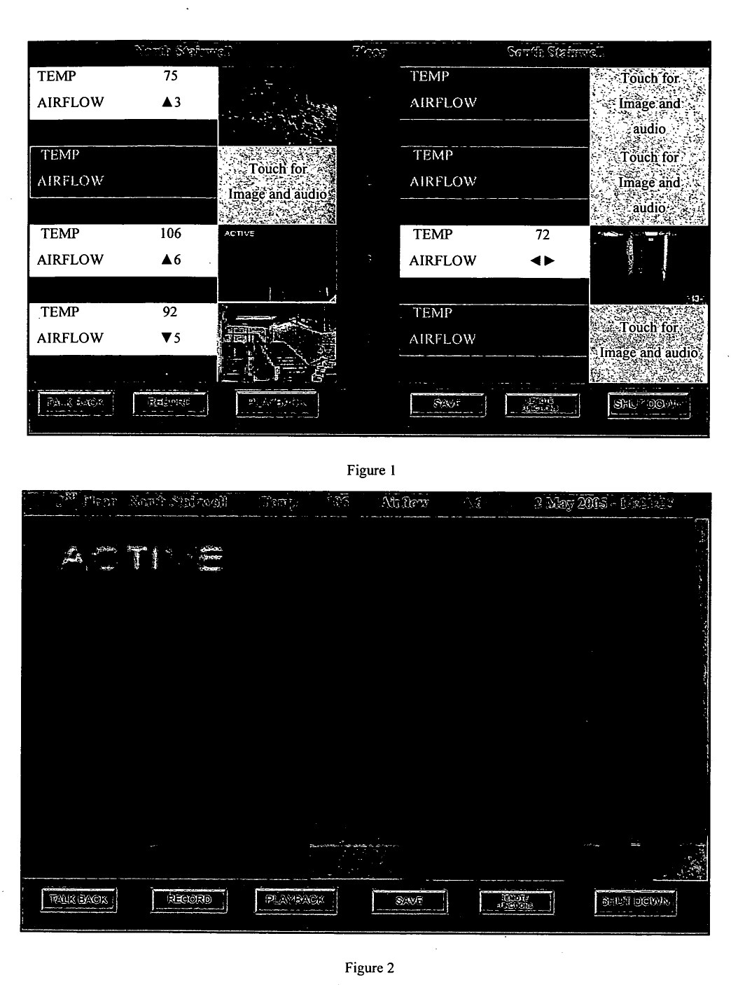

In normal operation, the Guardian is dormant with only the receiver and battery charger in operation. The Guardian can be queried by the portable Mobile Command Post (covered in a separate application) and asked to report its status. The nature of this report will depend on the type of sensor array that is installed. Typically the sensor array would consist of a microphone, a temperature sensor, a low-light video camera and a differential airflow sensor. The Guardian also returns a unique device identifier (similar to a MAC address). This data will be displayed on the Mobile Command Post with a graphic user interface that essentially portrays an elevation view of the structure with the appropriate data displayed in a highly intuitive fashion (FIG. 1). This touch-screen display enables the operator to select up to 4 thumbnail views simultaneously. By touching the thumbnail view, a larger image can be displayed (FIG. 2). The operator can now listen and talk back to the remote unit. With the information that the Guardian can provide to first responders, there is no need to send personnel into the structure to asses the situation. The occupants of the building can now be instructed as to a safe exit route. Since the devices are independent of any infrastructure and the network is self-organizing damage to the building or its infrastructure will have no impact on the efficacy of the Guardian system.

The Guardian is composed of various electronic components including a unique identification device, a field-changeable data acquisition module, a data server, a radio transmitter and, a power system consisting of a rechargeable battery and charging mechanism, an audio amplifier and loudspeaker as well as 575 Nm lamps to provide illumination capable of penetrating smoke. The radio system operates in the 13.360 to 13.410 MHz band which has been reserved by the Federal Communications Commission for use only in safety-of-life applications. Radio signals on these frequencies will penetrate buildings and are not subject to the multi-path distortion problems typically associated with VHF and microwave frequencies. The bandwidth at this frequency is adequate for the transmission of data, audio and slow-scan video.

### BRIEF DESCRIPTION OF THE DRAWING

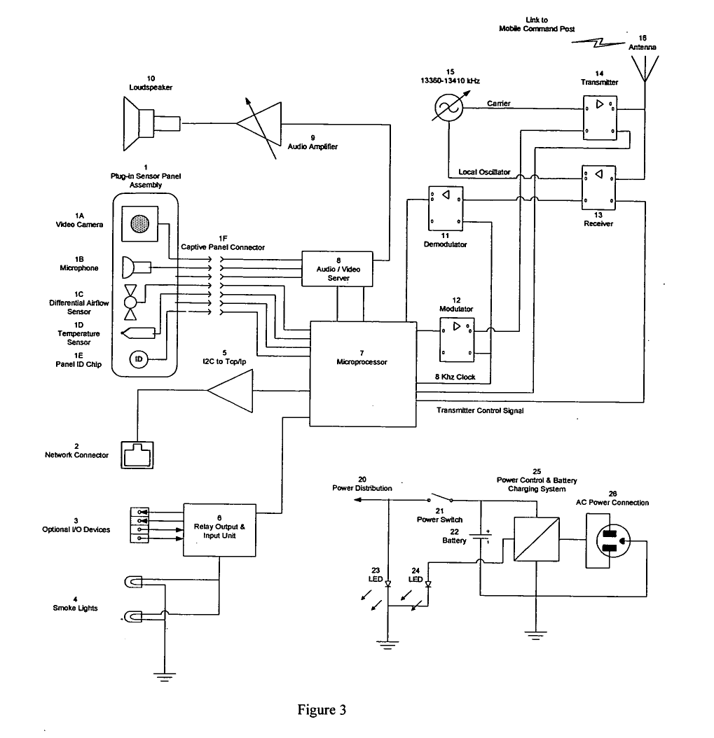

The invention is illustrated in FIG. 3. The sensor array 1 is a field replaceable panel containing various sensors. In the configuration shown, There is a low-light level video camera 1A, a sensitive microphone 1B, a vertical differential airflow sensor sensitive to 1 MBbar, an ambient temperature sensor 1C and a unique identifier chip. This array is connected to a bi-directional audio and video capture device 8 that also streams the data to a serial I2C bus which is directed to the microprocessor 7. An audio amplifier 9 and loudspeaker 10 capable of 10 watts output is connected to this media streaming chip. The microprocessor also sends the data stream to an I2C to TCP/IP converter and makes this data available at the RJ-45 connector 2. The data stream is sent to a pulse-width modulator 12 and the transmitter 14. A stable VXO signal source 15 provides the carrier and local oscillator signals for the transmitter and receiver. The microprocessor is also connected to an I/O buffer 6 for accessory analog and digital inputs and digital outputs 3 for operation of lamps 4, alarms, etc. The transmitter 14 and receiver 13 are connected to the loop antenna 16. The power system consists of a power connector 26, a battery trickle charging unit 25, indicator LEDs 23 and 24, a power switch 21 and a battery capable of running the unit for two hours.

What is claimed:

1. A system to provide details of the situation inside of a structure in an emergency or disaster without exposing search and rescue personnel to risk of life.
a. An electronic device that will capture and transmit audio and video data reliably from inside a structure without reliance on any installed infrastructure.
b. An electronic device that will transmit and receive audio signals for the purpose of directing occupants of a building to a safe exit
c. A system that operates without any reliance on preinstalled building systems.
d. A system that can support field-replaceable analog and digital data I/O devices without re-configuration.
e. A system that can relay disaster and emergency data to a portable device wirelessly from inside a structure.
f. A system that can relay and/or record disaster and emergency data from a portable mobile command post.
g. A system that can interconnect to a digital or analog recorder.

2. A self-contained system for emergency data acquisition and transmission with the following features:
a. A system powered by internal rechargeable batteries for a period of 2 hours.
b. A system that requires only a AC power outlet for installation.
c. A system that is self-identifying and self-organizing.
d. A system that can be reconfigured in the field.
e. A system that can be instantly deployed without complex set-up.
f. A system that can be operated by unskilled personnel with minimal or on-the-spot training.
